(19) United States
(12) Patent Application Publication
(10) Pub. No.: US 2015/0342240 A1
(43) Pub. Date: Dec. 3, 2015

(54) Nutritional Walnut-Based Compositions

(71) Applicant: Houram Shahrestani, Vancouver (CA)

(72) Inventor: Houram Shahrestani, Vancouver (CA)

(21) Appl. No.: 14/292,365

(22) Filed: May 30, 2014

(51) Int. Cl. A23L 1/36; A23L 1/223; A23L 2/02; A23L 1/237; A23L 1/23; A23L 1/221; A23L 1/222

(52) U.S. Cl. CPC A23L 1/366; A23L 1/2212; A23L 1/223; A23L 1/222; A23L 1/237; A23L 1/362; A23L 1/23; A23L 2/02; A23V 2002/00

(57) ABSTRACT

A high nutrition food spread providing walnut-based compositions are disclosed. The spreads have desirable taste and consistency characteristics as well as palatability. Generally, the composition is produced as a spread to be used on it's own or can be used in conjunction with olives or pickled vegetables. The composition may be used in many applications in place of products such as butter, margarine, jelly, jam, honey, hummus, tapenade or other similar products. The spread is lower in fat and cholesterol than many conventional spreads, but still provides a pleasing flavor and is compatible with many flavoring options.

### CROSS-REFERENCE TO RELATED APPLICATIONS

None

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### FIELD OF THE INVENTION

This invention relates to novel high nutrition food spreads. More particularly, to walnut-based high nutrition food spreads which, because of the formulation utilized, do not have the usually attendant disadvantages of food spreads containing high fat concentrations.

### DISCUSSION OF THE RELATED ART

Traditional food spreads such as peanut butter, jams, margarine and butter are commonplace in the kitchen. They may be used for cooking, baking, sandwiches and in conjunction with numerous food products. In many individuals, a significant source of their fat intake originates from spreads such as nut butter, oil, or margarine. Margarine-based spreads can contain 80% of fat by weight. The fat content is made up primarily of polysaturated fats which are hydrogenated in production. Hydrogenated products are readily acidified to produce free radical compounds known to be carcinogenic.

With a greater understanding for the role dietary fats play in significant health concerns such as cardiovascular disease, many consumers have begun seeking to reduce or eliminate food items with high percentage fat content from their diets. The health benefits of a low fat diet are well documented and well accepted and, in recent years, manufacturer's attention has been directed to producing healthier food spreads, in the form of reduced fat alternatives to the existing products.

One way to reduce the fat content of such spreads is to replace some of the fat with sweeteners, such as corn syrup. Aside from being lower in fat, sweetened spreads are generally lower in calories than unaltered butter or margarine. Another known technique is to substitute with high nutrition supplements such as soy.

However, some of the high nutrition supplements, including soy-based spreads suffer from the significant issue of poor palatability. It has been shown that many of the presently available spreads have numerous deleterious effects for the people consuming them. Because of its hygroscopic nature of soy protein, it absorbs moisture in the mouth rapidly upon contact leaving the consumer feeling dehydrated and turned off by the product.

Olive oil in another spread which has a variety of documented therapeutic benefits resulting from its chemical structure predominately composed of monounsaturated fatty acids. The therapeutic properties of oils from natural origins, such as olive oil and avocado oil have been widely documented. Olive oil has been associated with benefits to the gastrointestinal tract, increasing memory, decreasing mortality from heart disease due to increasing blood flow and softening skin. However, due to its flavor and consistency, olive oil has never been viewed as a replacement to the aforementioned traditional spreads.

A variety of different alternative have been proposed. U.S. Pat. Nos. 4,226,895, 4,284,655 and 4,509,727 disclose food spreads containing an oil in water emulsion. Various non-triglyceride substances have been described as potential fat-replacers in food products. Examples of such non-triglyceride substances are waxes, e.g. jojoba oil and hydrogenated jojoba oil, polysiloxanes, acylated glycerides, polyalkoxyglycerolethers, dicarboxylic acid esters, polyol fatty acid polyesters and the epoxy-extended derivatives thereof. Examples of disclosures of fat-replacers are U.S. Pat. Nos. 3,600,186, 4,005,195 and 4,005,196.

Honey is a common liquid sweetener utilized to add flavor to spreads and syrups. Compositions such as honey butter are made by mixing honey with melted butter or margarine. Honey butter may take a variety of different compositions with the primary difference being the proportions of honey and butter or margarine used.

Although the sweet taste of honey butter makes it more palatable for some, it has be linked to dietary problems for many who consume it. Ingestion of honey by young children can be a concern for parents as it is known to contain bacteria in particular bacterium clostridium botuli. In some children's digestive systems, the stomach fluids lack the requisite acidity to kill the botulinum bacteria and a resulting spread of bacteria can lead to botulism poisoning.

Many attempts have been made to formulate low fat spread products with reduced caloric content that address consumer's health concerns while still being desirable to ingest. Accordingly, it would be desirous in the art to have a spread product defined by improved nutritional characteristics, superior palatability, and greatly improved shelf-life with respect to the known oil-based and natural-oil based compositions. It would be advantageous to do so while avoiding the inherent health risks associated with many of the proposed spreads. The present invention effectuates these needs.

### SUMMARY

To address the above-described concerns, the inventor has developed walnut-based compositions that have improved nutritional characteristics over commonly used spreads. The present invention relates to a spreadable walnut-based composition. Generally, the composition is produced as a spread to be used on it's own or can be used in conjunction with olives or pickled vegetables. The invention can be used in many applications in place of products such as butter, margarine, jelly, jam, honey, hummus, tapenade or other similar products. Furthermore, the composition of the present invention may be utilized for baking, marinating, basting or any other cooking and/or food preparation application. The spread is lower in fat and cholesterol than many conventional spreads, but still provides a pleasing flavor and is compatible with many flavoring options.

In one embodiment, the invention is directed to a nutritional walnut-based spread comprising walnuts in a total amount ranging from about 35 wt. % to about 49 wt. %; at least one fruit or vegetable juice in a total amount ranging from about 15 wt. % to about 23 wt. %; at least one edible oil in a total amount ranging from about 10 wt. % to about 15 wt. %; and an acetic acid-based solution in a total amount ranging from about 5 wt. % to about 13 wt. %. All amounts are based on the total weight of the walnut-based spread.

Another embodiment of the invention is directed towards nutritional walnut-based spreads further comprising mint leaves in a total amount ranging from about 0.5 wt. % to about 1.5 wt. %; garlic in a total amount ranging from about 1.5 wt. % to about 2.5 wt. %; angelica powder 0.1-0.3 wt. %; salt in a total amount ranging from about 0.5 wt. % to about 1.5 wt. %.; and pepper in a total amount ranging from about 0.5 wt. % to about 1.5 wt. %. All amounts are based on the total weight of the walnut-based spread.

The term “edible oil” as used herein refers to all oils of plant origin, synthetic oils, and fish oils that are fit to be eaten. In a preferred embodiment the oil is at least one selected from the group consisting of olive oil, avocado oil, canola oil, soybean oil, sunflower oil, nut oils, walnut oil, peanut oil, safflower oil, cottonseed oil, coconut oil, rice bran oil, mustardseed oil camelina oil, chia oil, flaxseed oil, perilla oil, palm oil, fish oil, sesame oil, wheatgerm oil, jojoba oil and corn oil and combinations thereof. The term “olive oil” as used herein refers to all types of purity of olive oil known to one skilled in the art.

In a preferred embodiment the juice is at least one selected from the group consisting of cranberry juice, apple juice, orange juice, raspberry, blueberry, blackberry, pineapple juice, carrot juice, lemon juice, and tomato juice.

In a preferred embodiment, the garlic may be fresh garlic but those of ordinary skill in the relevant art will understand that powdered garlic may also be used without deviating from the scope of the present invention.

In a preferred embodiment, the acidic acid solution is a form of vinegar including, but is not limited to, distilled, balsamic, white, wine, spirit, malt, palm, kiwifruit, date coconut, and apple cider vinegar.

The description of the invention which follows, together with the accompanying examples should not be construed as limiting the invention to the examples shown and described, because those skilled in the art to which this invention pertains will be able to devise other forms thereof within the ambit of the appended claims.

### DETAILED DESCRIPTION

Illustrative embodiments of the invention are described below. The showings are for purposes of illustrating preferred embodiments and not for purposes of limiting the same. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

The preferred embodiment is related to a nutritional walnut-based composition that is developed to provide the nutritional benefits sought after by health conscious consumers while avoiding the negative attributes of currently available food spreads. Applicant's composition can be used as a substitute for many currently available spreads and may be utilized for baking, marinating, basting or any other cooking and/or food preparation.

The past compositions, included margarine, butter, and peanut spreads as well as marginally healthier alternative whose deleterious health effects have long been documented. Other such compositions that have gained popularity include those comprising the Middle Eastern spread hummus. Although the taste of this spread is appealing to some, many consumers experience gastrointestinal irritation linked to the ingredients used in its preparation. Applicant's composition overcomes these and other problems associated with the known food compositions while introducing additional health benefits unique to the walnut-based composition.

In the preferred embodiment, Applicant's composition can be consumed immediately following preparation without the need for additional ingredients or preparation steps such as heating or cooling. The composition is desirous on its own or as a complement to other food items. In one embodiment, the composition is mixed with olives to magnify the health benefits of the nutritional walnut-based composition. Olives are a well known source of fiber and fatty acids that, when ingested, have also been linked to noticeably increased levels of energy.

Furthermore, the preferred formulation is specifically designed to have a longer shelf-life than related food compositions while being more resistant to fluctuations in ambient temperature.

As with most food spreads, flavorings and color producing additives known in the art can be employed in whatever range is desired to yield a particular flavor or composition having the desired color and intensity of flavor. In addition, one or more of the following ingredients may be included or be substituted with an appropriate equivalent. They are given by way of example, not by limitation: cranberry juice, olive oil, fresh garlic, dried mint leaves, angelica powder, salt, and pepper.

### EXAMPLES OF THE PREFERRED EMBODIMENTS

In order to more fully teach what the Applicant regards as his invention, the following examples are given. It should be understood that the formulations set forth in the Examples are given by way of example only and are not to be construed as limiting the scope of the invention, except so far as they yield a nutritional walnut-based composition having the desired properties and characteristics.

Nutritional food spreads have been proposed in the past. By way of example, the following chart illustrates a formulation for a peanut butter-like and fruit preserve product from U.S. Pat. No. 5,034,742:

| INGREDIENT | AMOUNT | |
|---|---|---|
| Defatted Peanut Flour | 9.00 | lb |
| Water | 13.50 | lb |
| Corn Syrup | 6.75 | lb |
| Molasses | 1.875 | oz |
| Xanthan Gum | 0.57 | oz |
| Lecithin | 0.86 | oz |
| Sugar | 0.75 | lb |
| Salt | 6.75 | oz |
| Coloring | 0.93 | oz |
| Potassium Sorbate | 0.54 | oz |
| Flavorings | 2.40 | oz |

Similarly, and by way of example, the following chart illustrates a formulation for a multifunction spread from U.S. Pat. No. 6,203,842 where all amounts are based on the total weight of the composition:

| INGREDIENT | WEIGHT PERCENT |
|---|---|
| Oil blend | 49.5 |
| lecithin | 0.205 |
| distilled monoglyceride with an iodine | 0.3 |
| value less than or equal to 5 | |
| Flavor | 0.01 |
| Color | 0.0066 |
| Whey | 0.25 |
| EDTA | 0.007 |

The following ingredients are an example of one embodiment of of Applicant's nutritional walnut-based composition with the percentages being given by weight and, in all of the following embodiments which comprise garlic, the garlic may be either fresh garlic or garlic in the powdered form:

### Example 1

| INGREDIENT | WEIGHT PERCENT |
|---|---|
| Ground Walnuts | 48.2 |
| Cranberry Juice | 21.9 |
| Olive Oil | 14.4 |
| Garlic | 2.4 |
| Vinegar | 11.9 |
| Dried Mint Leaves | 0.8 |
| Angelica Powder | 0.4 |

The following ingredients are an another example of one embodiment of Applicant's nutritional walnut-based composition with the percentages being given by weight:

### Example 2

| INGREDIENT | WEIGHT PERCENT |
|---|---|
| Ground Walnuts | 48.3 |
| Cranberry Juice | 21.9 |
| Olive Oil | 14.2 |
| Vinegar | 11.9 |
| Garlic | 1.9 |
| Dried Mint Leaves | 0.6 |
| Angelica Powder | 0.2 |
| Salt | 0.8 |
| Pepper | 0.2 |

The following ingredients are yet another example of one embodiment of applicant's nutritional walnut-based composition with the percentages being given by weight:

### Example 3

| INGREDIENT | WEIGHT PERCENT |
|---|---|
| Ground Walnuts | 48.5 |
| Cranberry Juice | 21.9 |
| Olive Oil | 14.4 |
| Vinegar | 11.9 |
| Garlic | 2.1 |
| Salt | 0.8 |
| Pepper | 0.4 |

The following ingredients are another example of one embodiment of applicant's nutritional walnut-based composition with the percentages being given by weight:

### Example 4

| INGREDIENT | WEIGHT PERCENT |
|---|---|
| Ground Walnuts | 48.3 |
| Fruit Juice | 21.9 |
| Olive Oil | 14.2 |
| Vinegar | 11.9 |
| Garlic | 1.9 |
| Dried Mint Leaves | 0.6 |
| Angelica Powder | 0.2 |
| Salt | 0.8 |
| Pepper | 0.2 |

The following ingredients are another example of one embodiment of applicant's nutritional walnut-based composition with the percentages being given by weight:

### Example 5

| INGREDIENT | WEIGHT PERCENT |
|---|---|
| Ground Walnuts | 49 |
| Fruit Juice | 23 |
| Olive Oil | 15 |
| Vinegar | 13 |

Moreover, the following ingredients are another example of one embodiment of applicant's nutritional walnut-based composition with the percentages being given by weight:

### Example 6

| INGREDIENT | WEIGHT PERCENT |
|---|---|
| Ground Walnuts | 48.3 |
| Apple Juice | 21.9 |
| Olive Oil | 14.2 |
| Vinegar | 11.9 |
| Garlic | 1.9 |
| Dried Mint Leaves | 0.6 |
| Angelica Powder | 0.2 |
| Salt | 0.8 |
| Pepper | 0.2 |

The foregoing compositions are able to provide consumers with antioxidants; proteins that comprising essential amino acids; are a source iron, manganese, magnesium, phosphorus, zinc, and calcium; and comprise polyunsaturated fatty acid and vitamins B1, B2, B3, B5, B6, B9 & E.

Although the invention has been described with reference to specific embodiments, it will be understood by those skilled in the art that various changes may be made without departing from the scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the composition discussed herein may be implemented in a variety of embodiments, and that the foregoing discussion of certain of these embodiments does not necessarily represent a complete description of all possible embodiments, Rather, the detailed description, and the examples themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While a particular form of the invention has been illustrated and described, it will be apparent that various modifications can be made without departing from the spirit and scope of the invention. For example, the fruit juice in one embodiment of the composition will be effectuated using cranberry juice even though the inventor contemplates the possibility of using other fruit juices and varying methods of effectuating the same. Accordingly, is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the nutritional walnut-based composition with which that terminology is associated. In general, the terms used in the following claims should not be constructed to limit the walnut-based composition to the specific embodiments disclosed in the specification, unless the above description section explicitly define such terms. Accordingly, the actual scope encompasses not only the disclosed embodiments, but also all equivalent ways of practicing or implementing the disclosed composition. The above description of embodiments of the composition is not intended to be exhaustive or limited to the precise form disclosed above or to a particular field of usage. While specific embodiments of, and examples for, the walnut-based composition are described above for illustrative purposes, various equivalent modifications are possible which those skilled in the relevant art will recognize.

While certain aspects of the walnut-based composition are presented below in particular claim forms, the inventor contemplates the various aspects of the composition in any number of claim forms. Accordingly, the inventor reserves the right to add additional claims after filing the application to pursue such additional claim forms for other aspects of the nutritional walnut-based composition.

What is claimed is:

1. A nutritional walnut-based composition comprising a mixture of:
walnuts;
juice;
edible oil;
acetic acid;
garlic;
mint leaves;
angelica powder;
salt; and
pepper.

2. The nutritional walnut-based composition of claim 1 further comprising:
walnuts 25-49 wt. %;
juice 15-23 wt. %;
edible oil 10-15 wt. %;
acetic acid 5-13 wt. %;
garlic 1.5-2.5 wt. %;
mint leaves 0.5-1.5 wt. %;
angelica powder 0.1-0.3 wt. %;
salt 0.5-1.5 wt. %; and
pepper 0.5-1.5 wt. %.

3. The nutritional walnut-based composition of claim 1 wherein said juice is cranberry juice.

4. The nutritional walnut-based composition of claim 1 wherein said edible oil is olive oil.

5. The nutritional walnut-based composition of claim 1 wherein said acetic acid is vinegar.

6. A nutritional walnut-based composition comprising a mixture of:
walnuts;
juice;
edible oil; and
acetic acid.

7. The nutritional walnut-based composition of claim 6 further comprising:
walnuts 25-49 wt. %;
juice 15-23 wt. %;
edible oil 10-15 wt, %; and
acetic acid 5-13 wt. %.

8. The nutritional walnut-based composition of claim 6 further comprising:
garlic;
mint leaves;
angelica powder;
salt; and
pepper.

9. The nutritional walnut-based composition of claim 7 further comprising:
garlic 1.5-2.5 wt. %;
mint leaves 0.5-1.5 wt. %;
angelica powder 0.1-0.3 wt. %;
salt 0.5-1.5 wt. %; and
pepper 0.5-1.5 wt. %.

10. The nutritional walnut-based composition of claim 6 wherein said juice is cranberry juice.

11. The nutritional walnut-based composition of claim 6 wherein said edible oil is olive oil.

12. The nutritional walnut-based composition of claim 6 wherein said acetic acid is vinegar.
